(19) United States
(12) Patent Application Publication
(10) Pub. No.: US 2012/0018496 A1
(43) Pub. Date: Jan. 26, 2012

(54) Method and Apparatus for Forming a Wave Form Used to Make Wound Stents

(75) Inventors: PJ CARMODY, Knocknacarra (IE); Sean Moynihan, Tuam (IE); Gerard Clery, Oranmore (IE); Erik Griswold, Penngrove, CA (US)

(73) Assignee: Medtronic Vascular, Inc., Santa Rosa, CA (US)

(21) Appl. No.: 12/843,400

(22) Filed: Jul. 26, 2010

(51) Int. Cl. B23K 31/02; B21F 45/00

(52) U.S. Cl. 228/173.5; 140/71 R

(57) ABSTRACT

A method for forming a wave form for a stent includes clamping a formable material to a first die including a forming portion; drawing the formable material with the first die in a first direction; clamping the formable material to a second die at a location spaced from the first die, the second die including a forming surface; moving a forming member in between the first die and the second die in a second direction substantially perpendicular to the first direction and into contact with the formable material; and deforming the formable material by moving the forming member in the second direction while moving the first die towards the second die and/or moving the second die towards the first die.

### BACKGROUND OF THE INVENTION

1. Field of the Invention

The present invention is generally related to an apparatus and method for forming a wave form for a stent, and a method of manufacturing a stent including such a wave form.

2. Background of the Invention

A stent is typically a hollow, generally cylindrical device that is deployed in a body lumen from a radially contracted configuration into a radially expanded configuration, which allows it to contact and support a vessel wall. A plastically deformable stent can be implanted during an angioplasty procedure by using a balloon catheter bearing a compressed or “crimped” stent, which has been loaded onto the balloon. The stent radially expands as the balloon is inflated, forcing the stent into contact with the body lumen, thereby forming a support for the vessel wall. Deployment is effected after the stent has been introduced percutaneously, transported transluminally, and positioned at a desired location by means of the balloon catheter.

Stents may be formed from wire(s) or strip(s) of material, may be cut from a tube, or may be cut from a sheet of material and then rolled into a tube-like structure. While some stents may include a plurality of connected rings that are substantially parallel to each other and are oriented substantially perpendicular to a longitudinal axis of the stent, others may include a helical coil that is wrapped or wound around a mandrel aligned with the longitudinal axis at a non-perpendicular angle.

Stent designs that are comprised of wound materials generally have complex geometries so that the final stents may be precisely formed. The small size and complexity of some stent designs generally makes its formation difficult. Wound stents are formed such that when unsupported, they create the desired stent pattern and vessel support. This process generally involves winding a source material around a supporting structure such as a rod or mandrel and creating a helical or spring-like wrap pattern. To provide greater support, along this wrapped element, geometries are formed into the source material to better support the tissue in between each wrap, usually of sinusoidal nature.

### SUMMARY OF THE INVENTION

According to an aspect of the present invention, there is provided a method for forming a wave form for a stent. The method includes clamping a formable material to a first die that includes a forming portion, drawing the formable material with the first die in a first direction, and clamping the formable material to a second die at a location spaced from the first die. The second die includes a forming surface. The method includes moving a forming member in between the first die and the second die in a second direction substantially perpendicular to the first direction and into contact with the formable material, and deforming the formable material by moving the forming member in the second direction while moving the first die towards the second die and/or moving the second die towards the first die.

According to an aspect of the present invention, there is provided a forming apparatus configured to form a wave form for a stent out of a formable material. The wave form includes a plurality of substantially straight portions and a plurality of curved portions, with each curved portion connecting adjacent straight portions. The apparatus includes a first die that includes a forming portion. The first die is configured to be movable along two orthogonal axes. A first clamp is associated with the first die and configured to clamp the formable material to the first die. A second die includes a forming surface. The second die is configured to be movable along the two orthogonal axes. The second die is positioned relative to the first die in a spaced relation along a first one of the orthogonal axes. A second clamp is associated with the second die and configured to clamp the formable material to the second die. A forming member is configured to be movable along a second one of the orthogonal axes and substantially perpendicularly to the first one of the orthogonal axes. The forming member includes an elongated portion having an engaging surface at a distal end thereof. The engaging surface is configured to engage a first side of the formable material and form a curved portion of the wave form. The forming portion of the first die and the forming surface of the second die are configured to engage a second side of the formable material that is opposite the first side and form portions of additional curved portions of the wave form. The apparatus also includes a controller in communication with the first die, the second die, and the forming member. The controller is configured to control movement of the first die, the second die, and the forming member to control a length of each substantially straight portion of the wave form and to control a wavelength within the wave form.

According to an aspect of the present invention, there is provided a method for manufacturing a stent. The method includes forming a wave form that includes a plurality of substantially straight portions and a plurality of curved portions. Each curved portion connecting adjacent substantially straight portions. The forming includes clamping a formable material to a first die comprising a forming portion, drawing the formable material with the first die in a first direction, clamping the formable material to a second die at a location spaced from the first die, the second die comprising a forming surface, moving a forming member in between the first die and the second die in a second direction substantially perpendicular to the first direction and into contact with the formable material, and deforming the formable material by moving the forming member in the second direction while moving the first die towards the second die and/or moving the second die towards the first die. The method also includes wrapping the wave form around a mandrel to create a plurality of turns, and connecting selected curved portions of adjacent turns.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 is a schematic view of a stent according formed by a method according to an embodiment of the invention;

FIG. 2 is a schematic view of a wave form formed by a method according to an embodiment of the invention;

FIG. 3 is a schematic view of an embodiment of a forming apparatus configured to deform a formable material into the wave form of FIG. 2 and/or the wave form of the stent of FIG. 1;

FIG. 4 is a schematic view of part of the forming apparatus of FIG. 3 with the formable material being fed into the apparatus;

FIG. 5 is a schematic view of the forming apparatus of FIG. 4 after the formable material has been fed through a forming area and across a portion of a first die;

FIG. 6 is a schematic view of the forming apparatus of FIG. 5 after the first die and a second die have been moved towards each other and the first die and a forming member have been moved towards the formable material on opposite sides thereof;

FIG. 7 is a schematic view of the forming apparatus of FIG. 6 after a first clamp associated with the first die has clamped the formable material to the first die;

FIG. 8 is a schematic view of the forming apparatus of FIG. 7 after the first die has been moved in a direction away from the second die to draw a length of the formable material;

FIG. 9 is a schematic view of the forming apparatus of FIG. 8 after the second die has been moved in a direction away from the first die;

FIG. 10 is a schematic view of the forming apparatus of FIG. 9 after a second clamp has clamped the formable material to the second die;

FIG. 11 is a schematic view of the forming apparatus of FIG. 10 after the forming member has moved in a direction to deform the formable material and the first die has moved towards the second die and/or the second die has moved towards the first die;

FIG. 12 is a schematic view of the forming apparatus of FIG. 11 after the forming member has moved away from the formable material, the first clamp has released the formable material, and the first die has moved in a direction away from the forming member;

FIG. 13 is a schematic view of the forming apparatus of FIG. 12 after the first clamp has clamped the formable material to the first die;

FIG. 14 is a schematic view of the forming apparatus of FIG. 13 after the second clamp has released the formable material from the second die and the first die has moved in a direction away from the second die;

FIG. 15 is a schematic view of the forming apparatus of FIG. 14 after the second clamp has clamped the formable material to the second die and the first clamp has released the formable material from the first die;

FIG. 16 is a schematic view of the forming apparatus of FIG. 15 after the first die has moved towards the second die;

FIG. 17 is a schematic view of the forming apparatus of FIG. 16 after the first die has moved towards the formable material;

FIG. 18 is a schematic view of the forming apparatus of FIG. 17 after the first clamp has clamped the formable material to the first die;

FIG. 19 is a schematic view of the forming apparatus of FIG. 18 after the second clamp has released the formable material and the first die has moved away from the second die;

FIG. 20 is a schematic view of the forming apparatus of FIG. 19 after the second die has moved away from the first die;

FIG. 21 is a schematic view of the forming apparatus of FIG. 20 after the second clamp has clamped the formable material to the second die; and

FIG. 22 is a schematic view of the forming apparatus of FIG. 21 after the forming member has moved in a direction to deform the formable material and the first die has moved towards the second die and/or the second die has moved towards the first die.

### DETAILED DESCRIPTION OF EMBODIMENTS OF THE INVENTION

The following detailed description is merely exemplary in nature and is not intended to limit the invention or the application and use of the invention. Furthermore, there is no intention to be bound by any expressed or implied theory presented in the preceding technical field, background, brief summary or the following detailed description.

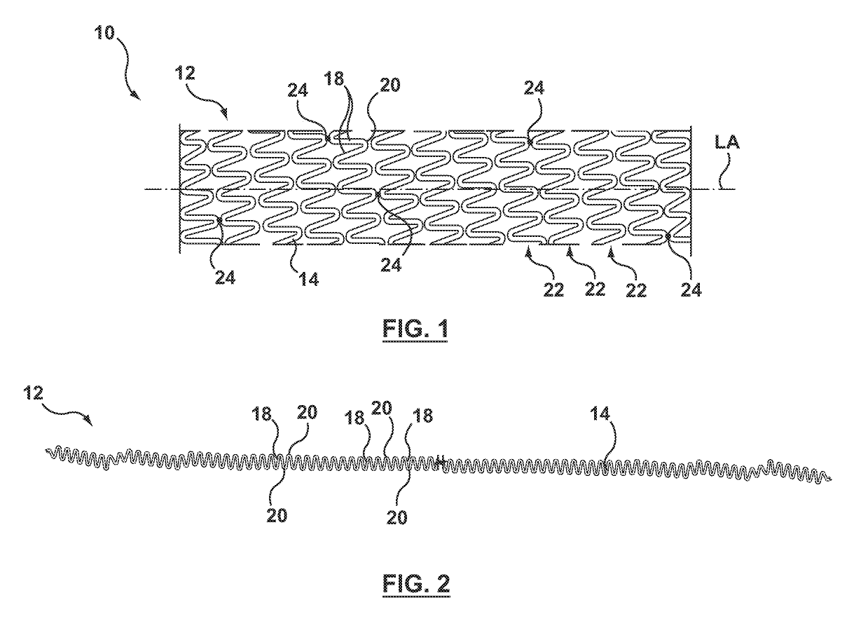

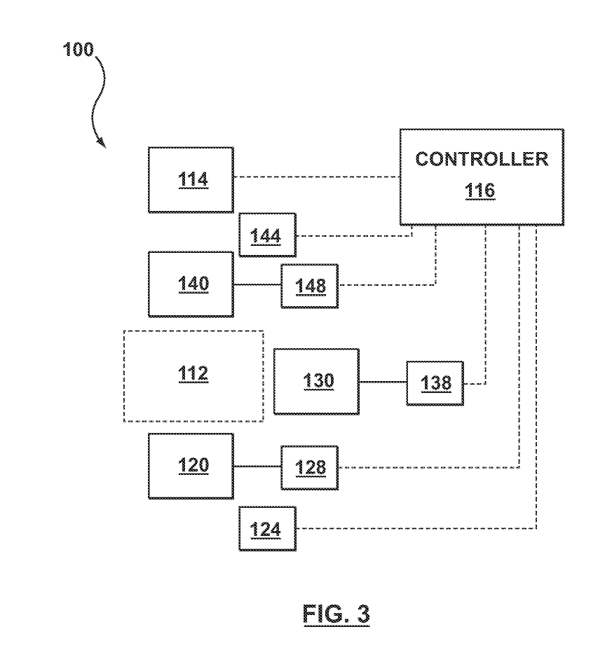

FIG. 1 schematically illustrates a stent 10 that has been manufactured according to an embodiment of the present invention. The stent 10 is generally cylindrical in shape and has a longitudinal axis LA extending through the center of the stent 10. The stent 10 includes a continuous wave form 12 that is formed from a formable material 14 using a forming apparatus 100 (illustrated schematically in FIG. 3) according to embodiments of the present invention, as discussed in further detail below.

As illustrated in FIG. 2, the wave form 12 may be formed so that the wave form 12 includes a plurality of struts 18 and a plurality of crowns 20. Each crown 20 is a curved portion or turn within the wave form 12 that connects adjacent struts 18 to define the continuous wave form 12. As shown in FIG. 2, the struts 18 are substantially straight portions of the wave form 12. In other embodiments, the struts 18 may be slightly bent or have other shapes, such as a sinusoidal wave, for example. The illustrated embodiment is not intended to be limiting in any way.

After the wave form 12 has been formed by forming apparatus 100, the wave form 12 may be wrapped, at a pitch, around a mandrel that has a longitudinal axis that will coincide with the longitudinal axis LA of the stent 10, so as to form a helix having multiple turns 22, as illustrated in FIG. 1. Select crowns 20 of adjacent turns 22 may be connected together, as represented by connections 24. The connections 24 may be formed by fusing the select crowns 20 together, by welding the select crowns 20 together, or by using any other suitable method to connect portions of adjacent turns 22 together.

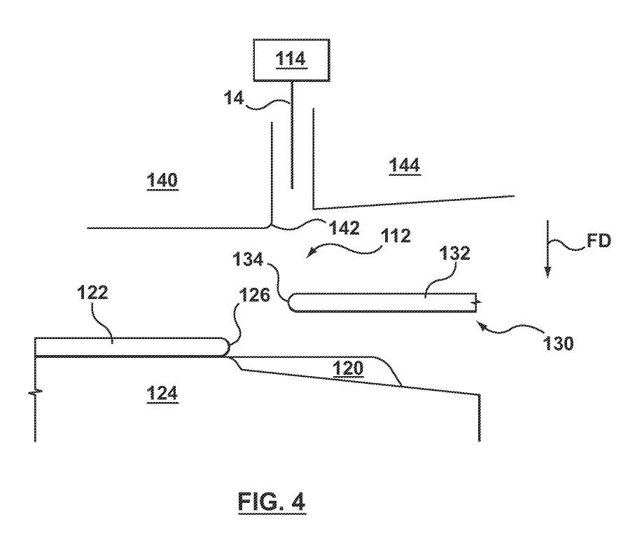

FIGS. 3 and 4 illustrate schematic views of an embodiment of a forming apparatus 100 that is configured to deform the formable material 14 into a desired shape, such as the wave form 12 illustrated in FIG. 2. The forming apparatus 100 includes a feeder 114 that is constructed and arranged to receive a supply of the formable material 14 and to provide the formable material 14 to a forming area 112 within the apparatus 100. As illustrated, the forming apparatus 100 also includes a first die 120, a forming member 130, and a second die 140. The first die 120 is configured to be moved by suitable actuators 128 that are configured to move the first die 120 along two orthogonal axes. The forming member 130 is configured to be moved by suitable actuators 138 that are configured to move the forming member 130 along the two orthogonal axes, and the second die 140 is configured to be moved by suitable actuators 148 that are configured to move the second die 140 along the two orthogonal axes. A controller 116 is in signal communication with the feeder 114, and the actuators 128, 138, 148, so that movement of the formable material 14, the first die 120, the second die 140, and the forming member 130 may be coordinated to create the desired wave form 12, as discussed in greater detail below.

FIG. 4 schematically illustrates a more detailed view of a portion of the forming apparatus 100 that includes the forming area 112. As illustrated, the feeder 114 is configured to feed the formable material 14 in a first direction FD towards the forming area 112. The feeder 114 may be configured to actively feed the formable material 14 in the first direction FD, or may be configured to passively feed the formable material 14 by allowing the formable material 14 to be drawn from the feeder 114, as discussed in further detail below.

The first die 120 includes a finger-like forming portion 122 having an engaging surface 126 configured to engage the formable material 14 on one side thereof and deform the formable material 14 into a desired shape, as discussed in further detail below. A first clamp 124 is configured to clamp the formable material 14 against the first die 120. The first clamp 124 may be carried by the first die 120 so that the first clamp 124 may move with the first die 120, yet be configured to move relative to the first die 120 so that the formable material 14 may be clamped to the first die 120, and released from the first die 120, as desired. The first clamp 124 may also be in signal communication with the controller 116 so that the controller 116 may control movement of the first clamp 124 relative to the first die 120, as illustrated in FIG. 3.

As illustrated in FIG. 4, the forming member 130 includes an elongated, or finger-like, portion 132 that has an engaging surface 134 at a distal end thereof. The engaging surface 134 is configured to engage the formable material 14 on one side thereof and deform the formable material 14 into a desired shape, as discussed in further detail below.

The second die 140 includes a forming surface 142 that is configured to engage the formable material 14. A second clamp 144 that is associated with the second die 140 is configured to clamp the formable material 14 to the second die 140, and release the formable material 14 from the second die 140, as desired. In an embodiment, the second clamp 144 may be carried by the second die 140 so that the second clamp 144 may also be moved by the actuators 148. In an embodiment, the second clamp 144 may be moved in the X and Y directions by its own actuators (not shown).

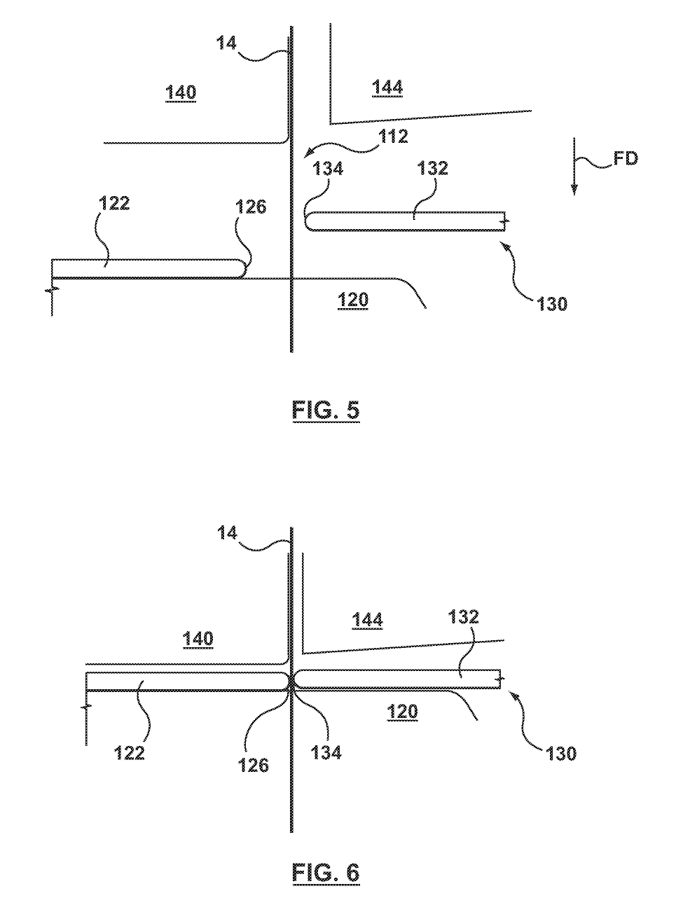

A method for forming the wave form 12 of the stent 10 with the forming apparatus 100 will now be described with respect to FIGS. 5-22. After a suitable length of formable material 14 has been fed through the second die 140, the forming area 112, and the first die 120, as illustrated in FIG. 5, the first die 120 (and the first clamp 124) may be moved by the actuators 128 towards the second die 140 to a predetermined position relative to the second die 140, so that the engaging surface 126 is in contact with or near the formable material 14, as illustrated in FIG. 6. The forming member 130 may also be moved by the actuators 138 to a position near the second die 140 so that the engaging surface 134 is in contact with or near the formable material 14 at a position that is opposite the engaging surface 126 of the first die 120.

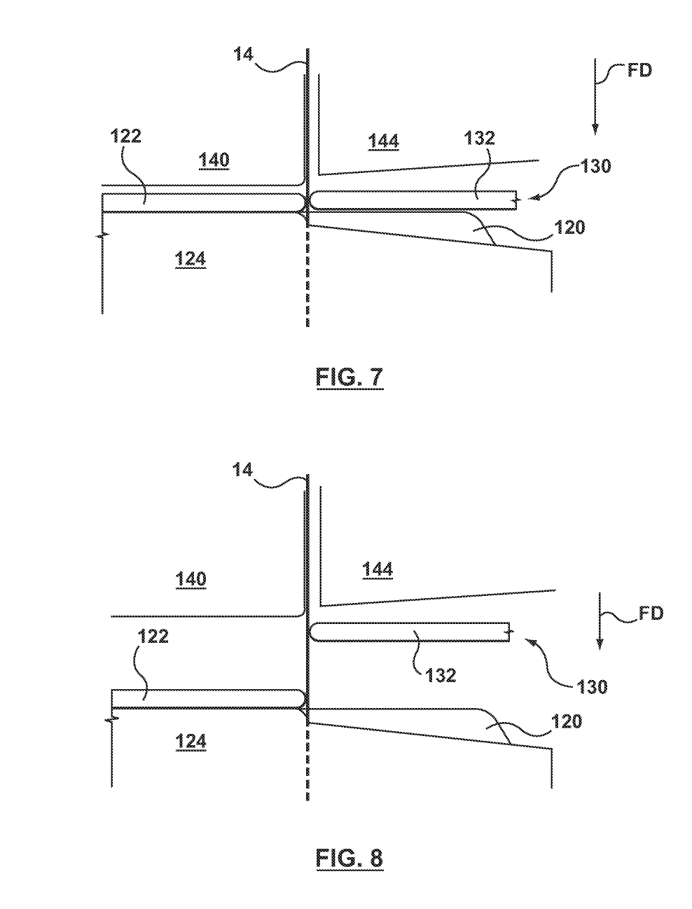

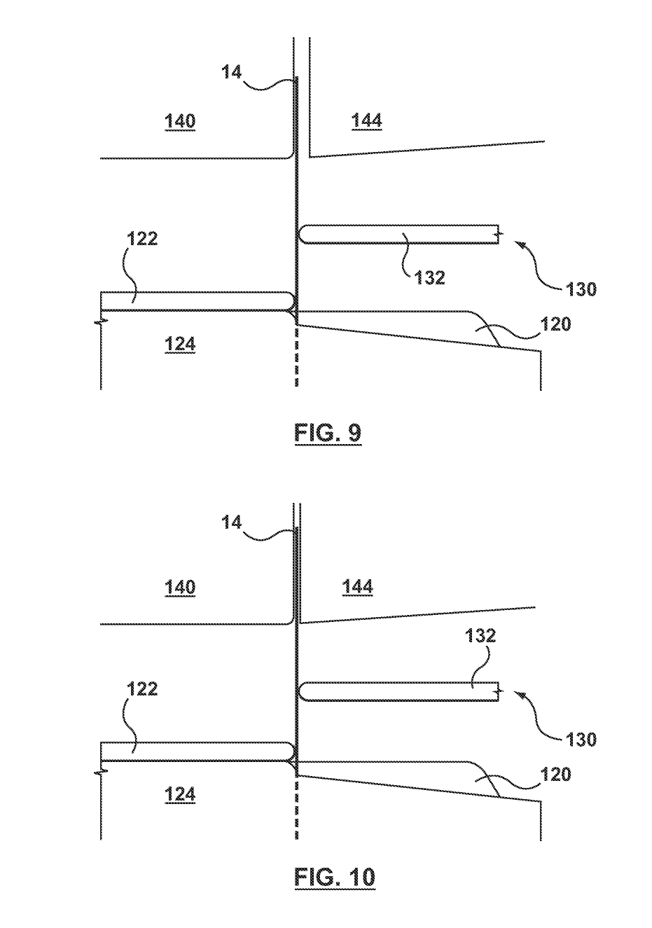

As illustrated in FIG. 7, the formable material 14 may then be clamped to the first die 120 with the first clamp 124 so that the formable material 14 is clamped in between the first clamp 124 and the first die 120. The formable material 14 may then be drawn in the first direction FD with the first die 120, as illustrated in FIG. 8. After the formable material 14 has been drawn by the desired predetermined length, the second die 140 and the second clamp 144 may be moved into position by being moved away from the first die 120, as illustrated in FIG. 9. The second clamp 144 may then be moved to clamp the formable material 14 to the second die 140, so that the formable material 14 is clamped in between the second clamp 144 and the second die 140, as illustrated in FIG. 10.

With the first die 120 and the second die 140 in their respective desired positions, and the formable material 14 firmly clamped to the first die 120 with the first clamp 124 and to the second die 140 with the second clamp 144, the forming member 130 may be moved in a second direction SD that is substantially perpendicular to the first direction FD so that the engaging surface 134 of the finger-like portion 132 of the forming member 130 engages the formable material 14 on one side thereof. The forming member 130 continues to move in the second direction SD, which causes the formable material 14 to deform and begin to wrap around the finger-like portion 132 of the forming member 130 and causes the formable material 14 to engage the engaging surface 126 of the finger-like portion 122 of the first die 120 and deform against the engaging surface 126, as illustrated in FIG. 11. The formable material 14 also deforms against the forming surface 142 of the second die 140, as also illustrated in FIG. 11.

At the same time or about the same time that the forming member 130 is moved in the second direction SD, the first die 120 (with the first clamp 124) may be moved towards the second die 140 (with the second clamp 144), and may also be moved slightly in the second direction SD. As illustrated in FIG. 11, the movement of the forming member 130 and the first die 120, and the deformation of the formable material 14 by the engaging surfaces 126, 134, 142 creates two struts or substantially straight portions 18, and a full curved portion or crown 20 in between the two struts 18 to start the wave form 12 that is illustrated in FIG. 2. In addition, the engaging surfaces 126, 142 each deform the formable material 14 such that two half-crowns, i.e., portions of two curved portions at also formed at the ends of the struts 18 that are connected to the full crown 20 formed by the engaging surface 134 of the forming member 130. In an embodiment, the second die 140 (with the second clamp 144) may also be moved towards the first die 120, as the first die 120 moves towards the second die 140. In an embodiment, the second die 140 may be moved towards the first die 120 while the first die 120 is stationary.

The amount of movement of the forming member 130 and the first die 120 (and second die 140, if applicable) influences the length of the formed struts 18 and size of the crowns 20. The controller 116 may be programmed so that the lengths of adjacent struts 18 in the wave form 12 are different, or are the same, as desired.

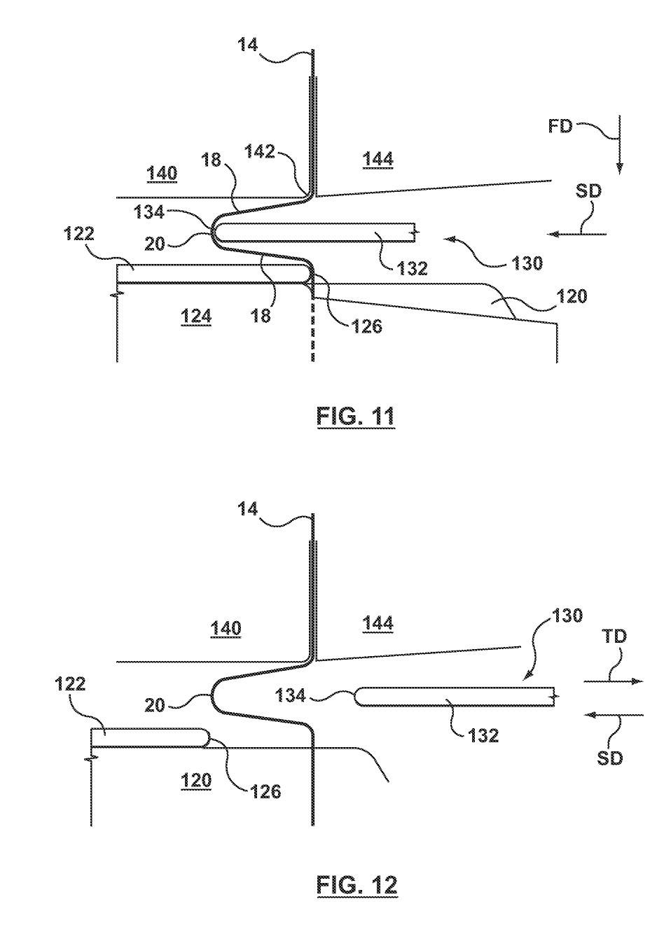

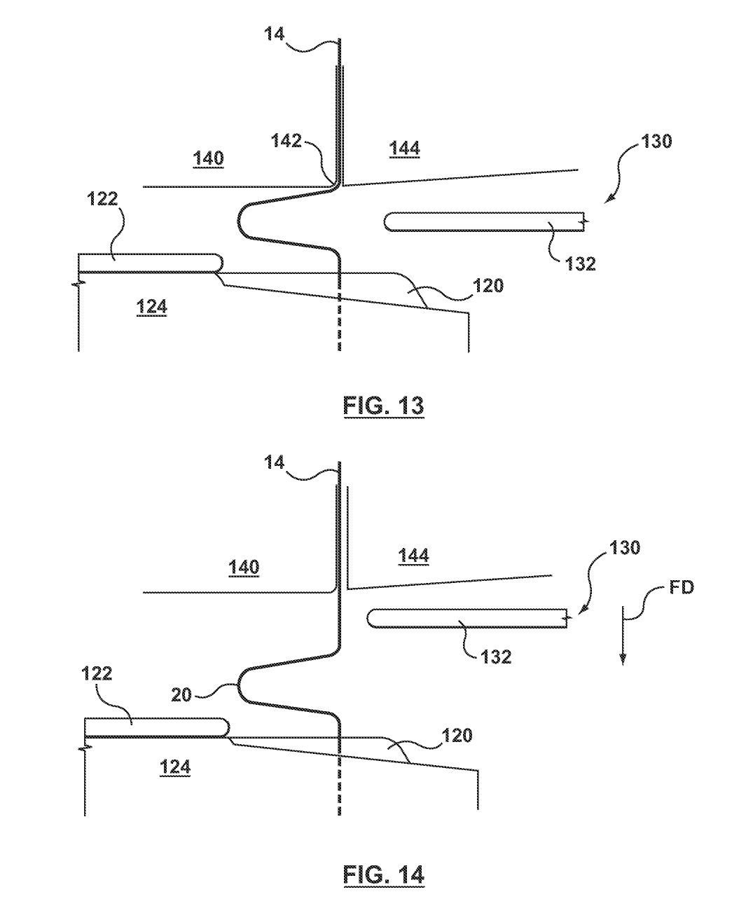

As illustrated in FIG. 12, after the crown 20 has been formed, the forming member 130 may be moved away from the formable material 14 in a third direction TD that is opposite the second direction SD and at the same time, or about the same time, the first clamp 124 may release the formable material 14, and the first die 120 may be moved away from the formable material 14 in the second direction SD. This movement causes the engaging surfaces 134, 126 to disengage from the formable material 14, and allows the finger-like portion 132 of the forming member 130 and the finger-like forming portion 122 of the first die 120 to clear the formable material 14. As illustrated in FIG. 13, the first clamp 124 may then clamp the formable material 14 to the first die 120, and the first die 120 and the first clamp 124 may move away from the second die 140 in the first direction FD.

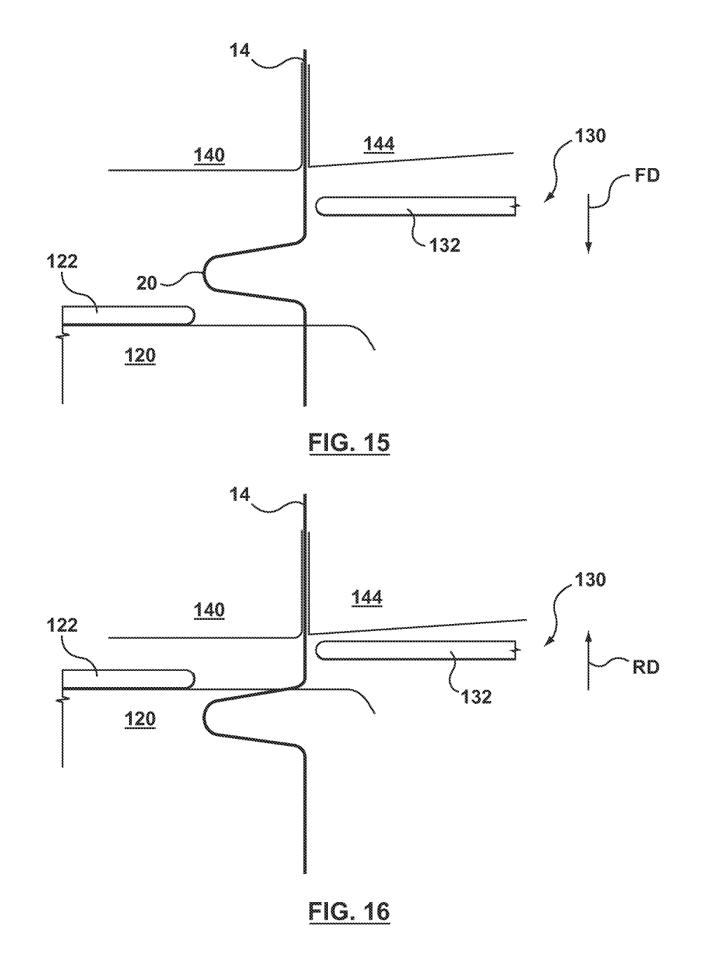

To start forming the next part of the wave form 12, the second clamp 144 may clamp the formable material 14 to the second die 140, the first clamp 124 may release the formable material 14 from the first die 120, and the second die 140 may move towards the first die 120 with the formable material 14 to move the newly formed crown 20 and struts 18 in the first direction FD, as illustrated in FIGS. 15 and 16. At the same time or about the same time, the first die 120 may be moved in a fourth direction RD that is opposite the first direction FD and towards the second die 120, as illustrated in FIG. 16.

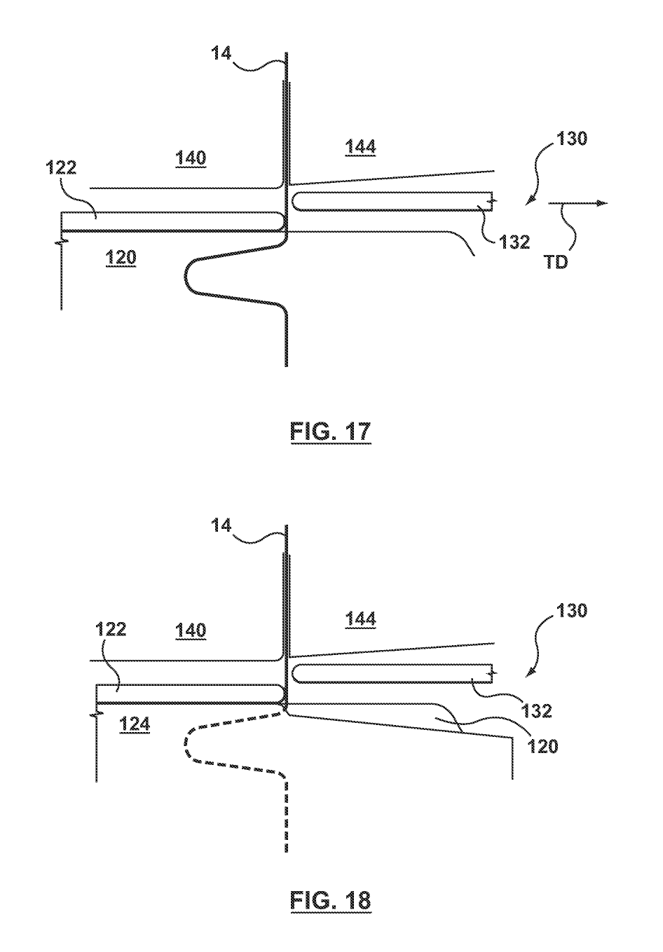

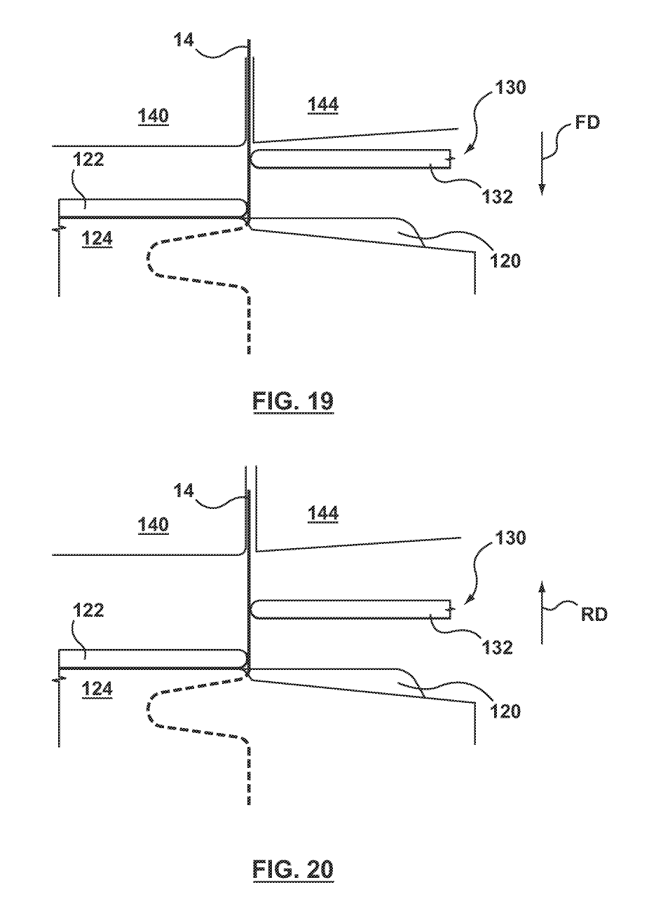

The first die 120 may then be moved in the third direction TD and towards the formable material 14, as illustrated in FIG. 17, so that the engaging surface 126 of the forming portion 122 of the first die 120 is in contact with or near the formable material. As illustrated in FIG. 18, the first clamp 124 may then clamp the formable material 14 to the first die 120. The second clamp 144 may then release the formable material 14 from the second die 140, and the formable material 14 may be drawn again in the first direction FD by the first die 120 and the first clamp 124, as illustrated in FIG. 19.

As illustrated in FIG. 20, the second die 140 (and the second clamp 144) may then be moved in the fourth direction RD away from the first die 120, and the second clamp 144 may clamp the formable material 14 to the second die 140, as illustrated in FIG. 21.

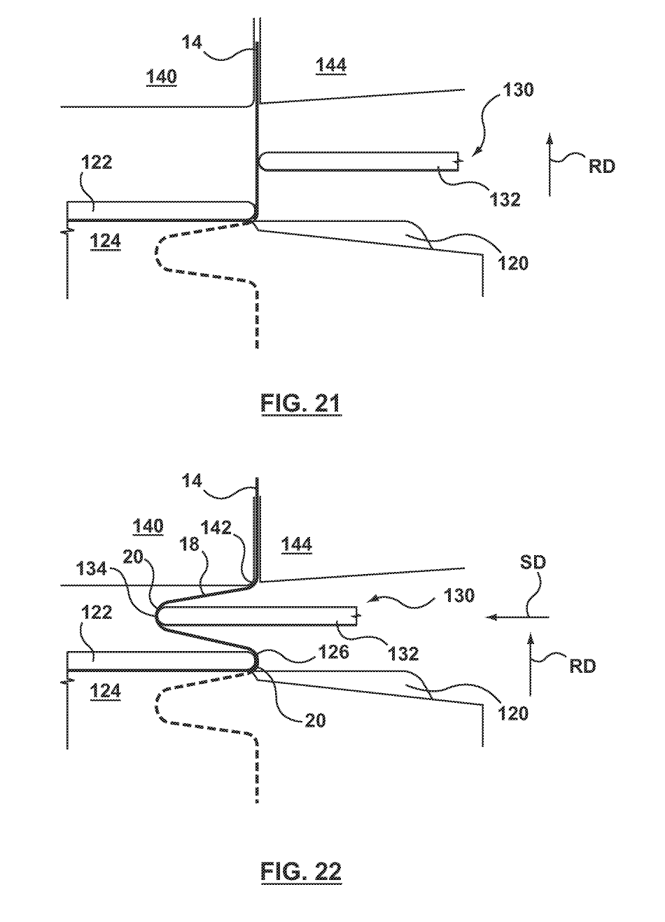

With the first die 120 and the second die 140 in their respective desired positions, and the formable material 14 firmly clamped to the first die 120 with the first clamp 124 and to the second die 140 with the second clamp 144, the forming member 130 may be moved in the second direction SD that is substantially perpendicular to the first direction FD so that the engaging surface 134 of the finger-like portion 132 of the forming member 130 engages the formable material 14 on one side thereof. The forming member 130 continues to move in the second direction SD, which causes the formable material 14 to deform and begin to wrap around the finger-like portion 132 of the forming member 130 and causes the formable material 14 to engage the engaging surface 126 of the finger-like portion 122 of the first die 120 and deform against the engaging surface 126, as illustrated in FIG. 22. The formable material 14 also deforms against the forming surface 142 of the second die 140, as also illustrated in FIG. 22.

At the same time or about the same time that the forming member 130 is moved in the second direction SD, the first die 120 (with the first clamp 124) may be moved towards the second die 140 (with the second clamp 144) in the fourth direction, and may also be moved slightly in the second direction SD. The movement of the forming member 130 and the first die 120, and the deformation of the formable material 14 by the engaging surfaces 126, 134, 142 creates two additional struts or substantially straight portions 18, and a full curved portion or crown 20 in between the two struts 18 to continue the wave form 12 that is illustrated in FIG. 2. In addition, the engaging surface 126 of the first die 120 deforms the formable material 14 in a manner that finishes the curved portion or crown 20 that was started by the engaging surface 142 of the second die 140 in the previous cycle described above with respect to FIG. 11. In addition, the engaging surface 142 deforms the formable material 14 such that another half-crown, i.e., portion of a curved portion, may be formed at the end of one of the newly formed substantially straight portions or struts 18. In an embodiment, the second die 140 (with the second clamp 144) may also be moved towards the first die 120, as the first die 120 moves towards the second die 140. In an embodiment, the second die 140 may be moved towards the first die 120 while the first die 120 is stationary.

As described above, the amount of movement of the forming member 130 and the first die 120 (and second die 140, if applicable) influences the length of the formed struts 18 and size of the crowns 20. In addition, the amount of movement of the forming member 130 and the first die 120 influences the wave lengths within the wave form 12. The controller 116 may be programmed so that the lengths of adjacent struts 18 in the wave form 12 are different, or are the same, as desired. The method may continue in the same manner described above until the desired wave form 12 is created.

The controller 116 may be pre-programmed with the desired wave form 12 and corresponding signals may be communicated to the feeder 114, the actuators 128, 138, 148 that move the first die 120, the forming member 130, and the second die 140, respectively, as well as the first clamp 124 and the second clamp 134. The forming apparatus 100 may use multi-axis motions to deform the formable material 14 and create a specific wave form or stent pattern that may then be used to create a stent having substantially perpendicular ends when wound about mandrel or other suitable structure. In an embodiment, the forming apparatus uses a multi-slide to create the multi-axis motions, but it is not necessary to use a multi-slide to create such motions. Other arrangements are contemplated to be within the scope of the invention.

The formable material 14 may be a wire or strip material that plastically deforms when deformed by the first die 120, the forming member 130, and the second die 140 so that the wave form 12 generally holds its shape after being formed. By adjusting the shape and size of the finger-like forming portion 122 of the first die 120, the finger-like forming portion 132 of the forming member 130, and the forming surface 142 of the second die 140, the relative motions of the first die 120, the forming member 130, and the second die 140 in relation to each other, the formable material 14, and the feed rate or draw rate and/or movement of the feeder 114, various amplitudes, periods, and shapes may be created within the wave form to form the overall desired shape for the stent.

Embodiments of the stents made using the method and apparatus discussed above may be formed from a wire or a strip of suitable material. In certain embodiments, the stents may be formed, i.e., etched or cut, from a thin tube of suitable material, or from a thin plate of suitable material and rolled into a tube. Suitable materials for the stent include but are not limited to stainless steel, iridium, platinum, gold, tungsten, tantalum, palladium, silver, niobium, zirconium, aluminum, copper, indium, ruthenium, molybdenum, niobium, tin, cobalt, nickel, zinc, iron, gallium, manganese, chromium, titanium, aluminum, vanadium, and carbon, as well as combinations, alloys, and/or laminations thereof. For example, the stent may be formed from a cobalt alloy, such as L605 or MP35N®, Nitinol (nickel-titanium shape memory alloy), ABI (palladium-silver alloy), Elgiloy® (cobalt-chromium-nickel alloy), etc. It is also contemplated that the stent may be formed from two or more materials that are laminated together, such as tantalum that is laminated with MP35N®. The stents may also be formed from wires having concentric layers of different metals, alloys, or other materials. Embodiments of the stent may also be formed from hollow tubes, or tubes that have been filled with other materials. The aforementioned materials and laminations are intended to be examples and are not intended to be limiting in any way.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient roadmap for implementing an exemplary embodiment of the invention, it being understood that various changes may be made in the function and arrangement of members described in an exemplary embodiment without departing from the scope of the invention as set forth in the appended claims.

What is claimed is:

1. A method for forming a wave form for a stent, the method comprising:
clamping a formable material to a first die comprising a forming portion;
drawing the formable material with the first die in a first direction;
clamping the formable material to a second die at a location spaced from the first die, the second die comprising a forming surface;
moving a forming member in between the first die and the second die in a second direction substantially perpendicular to the first direction and into contact with the formable material; and
deforming the formable material by moving the forming member in the second direction while moving the first die towards the second die and/or moving the second die towards the first die.

2. The method according to claim 1, wherein the forming portion of the first die and the forming surface of the second die deform the formable material as the forming member deforms the formable material.

3. The method according to claim 1, further comprising
releasing the formable material from the first die;
moving the first die in the second direction;
moving the forming member away from the formable material in a third direction that is opposite the second direction;
clamping the formable material to the first die;
releasing the formable material from the second die;
drawing the formable material with the first die in the first direction;
clamping the formable material to the second die;
releasing the formable material from the first die;
moving the first die in the third direction and in a fourth direction that is opposite the first direction;
clamping the formable material to the first die;
moving the forming member in between the first die and the second die in the second direction and into contact with the formable material; and
deforming the formable material by moving the forming member in the second direction while moving the first die towards the second die and/or moving the second die towards the first die.

4. The method according to claim 4, wherein distances moved during said deforming the formable member is variable between cycles.

5. The method according to claim 4, wherein distances moved during said drawing is variable between cycles.

6. The method according to claim 1, wherein the formable material comprises a wire.

7. The method according to claim 1, wherein the formable material comprises a strip of material.

8. A forming apparatus configured to form a wave form for a stent out of a formable material, the wave form comprising a plurality of substantially straight portions and a plurality of curved portions, each curved portion connecting adjacent straight portions, the apparatus comprising:
a first die comprising a forming portion, the first die configured to be movable along two orthogonal axes;
a first clamp associated with the first die and configured to clamp the formable material to the first die;
a second die comprising a forming surface, the second die configured to be movable along the two orthogonal axes, the second die being positioned relative to the first die in a spaced relation along a first one of the orthogonal axes;
a second clamp associated with the second die and configured to clamp the formable material to the second die;
a forming member configured to be movable along a second of the orthogonal axes and substantially perpendicularly to the first one of the orthogonal axes, the forming member comprising an elongated portion having an engaging surface at a distal end thereof, the engaging surface being configured to engage a first side of the formable material and form a curved portion of the wave form;
the forming portion of the first die and the forming surface of the second die being configured to engage a second side of the formable material that is opposite the first side and form portions of additional curved portions of the wave form; and
a controller in communication with the first die, the second die, and the forming member, the controller being configured to control movement of the first die, the second die, and the forming member to control a length of each substantially straight portion of the wave form and to control a wavelength within the wave form.

9. The forming apparatus according to claim 9, further comprising a first actuator in communication with the controller and configured to move the first die, a second actuator in communication of the controller and configured to move the second die, and a third actuator in communication with the controller and configured to move the forming member.

10. The forming apparatus according to claim 9, wherein the formable material is a wire.

11. The forming apparatus according to claim 9, wherein the formable material is a strip of material.

12. A method for manufacturing a stent, the method comprising:
forming a wave form comprising a plurality of substantially straight portions and a plurality of curved portions, each curved portion connecting adjacent substantially straight portions, said forming comprising
clamping a formable material to a first die comprising a forming portion,
drawing the formable material with the first die in a first direction,
clamping the formable material to a second die at a location spaced from the first die, the second die comprising a forming surface,
moving a forming member in between the first die and the second die in a second direction substantially perpendicular to the first direction and into contact with the formable material, and
deforming the formable material by moving the forming member in the second direction while moving the first die towards the second die and/or moving the second die towards the first die;
wrapping the wave form around a mandrel to create a plurality of turns; and
connecting selected curved portions of adjacent turns.

13. The method according to claim 13, where said connecting comprises fusing selected curved portions of adjacent turns.

14. The method according to claim 13, wherein said connecting comprises fusing selected curved portions of adjacent turns.

15. The method according to claim 13, wherein the forming portion of the first die and the forming surface of the second die deform the formable material as the forming member deforms the formable material.

16. The method according to claim 13, wherein said forming the wave form further comprises
releasing the formable material from the first die;
moving the first die in the second direction;
moving the forming member away from the formable material in a third direction that is opposite the second direction;
clamping the formable material to the first die;
releasing the formable material from the second die;
drawing the formable material with the first die in the first direction;
clamping the formable material to the second die;
releasing the formable material from the first die;
moving the first die in the third direction and in a fourth direction that is opposite the first direction;
clamping the formable material to the first die;
moving the forming member in between the first die and the second die in the second direction and into contact with the formable material; and
deforming the formable material by moving the forming member in the second direction while moving the first die towards the second die and/or moving the second die towards the first die.

17. The method according to claim 16, wherein distances moved during said deforming the formable member is variable between cycles.

18. The method according to claim 16, wherein distances moved during said drawing is variable between cycles.

19. The method according to claim 13, wherein the formable material comprises a wire.

20. The method according to claim 13, wherein the formable material comprises a strip of material.
